(19) United States
(12) Patent Application Publication
(10) Pub. No.: US 2022/0245262 A1
(43) Pub. Date: Aug. 4, 2022

(54) SECURE INFORMATION STORAGE, TRANSFER AND COMPUTING

(71) Applicant: SHIELD CRYPTO SYSTEMS INC., Toronto (CA)

(72) Inventors: Alhassan Khedr, Toronto (CA); Glenn Gulak, Toronto (CA)

(21) Appl. No.: 17/617,406

(22) PCT Filed: Jun. 12, 2020
(86) PCT No.: PCT/CA2020/050827

§ 371 Date: Dec. 8, 2021

Related U.S. Application Data
(60) Provisional application No. 62/860,823, filed on Jun. 13, 2019.

(51) Int. Cl. G06F 21/60; G06F 21/72; H04L 9/00

(52) U.S. Cl. CPC G06F 21/602; H04L 9/0877; H04L 9/008; G06F 21/72

(57) ABSTRACT

The present disclosure relates generally to homomorphic encryption, and specifically to using homomorphic encryption for secure information storage, transfer and computing. Described are systems for governing information transfers and systems for secure financial processing that include a hardware security module configured to generate a public key and a corresponding private key, homomorphically re-encrypt a set of confidential information into an encrypted information package, and make the encrypted information package available to be communicated.

### FIELD OF THE INVENTION

The present specification relates generally to homomorphic encryption, and specifically to using homomorphic encryption for secure information storage, transfer and computing.

### BACKGROUND OF THE INVENTION

Privacy is of great importance. Many service providers hold onto information about their customers or users in order to provide more convenient service. Customers or users are often prepared to authorize the use of this information for one or more purposes in order to facilitate the delivery of convenient service.

However, this stored information is often vulnerable to theft or misuse, which may be of special concern if the information is confidential information such as banking information or personally identifiable information.

While companies which hold onto information about their customers employ security measures to protect the information from theft or misuse, if an actor is able to bypass the security measures the actor is able to access the information and use it for purposes other than what the customers or users initially provided the information for.

Therefore, it would be desirable to have a secure information storage, transfer and computing system and method that maintains confidential information in an encrypted state and enables transactions without decrypting the confidential information.

### SUMMARY OF THE INVENTION

In an embodiment of the present invention, there is provided a system for governing information transfers, comprising: at least one information provider processor implementing at least one hardware security module; and at least one information recipient processor communicatively coupled to the at least one information provider processor, the at least one information provider processor configured to receive a set of confidential information, the at least one information provider processor configured to provide the set of confidential information to the at least one hardware security module, the at least one hardware security module configured to generate a public key and a corresponding private key, the at least one hardware security module configured to homomorphically encrypt the set of confidential information into an encrypted information package, the at least one hardware security module configured to make the encrypted information package available to be communicated to the at least one information recipient processor, and the at least one information recipient processor configured to request the encrypted information package and receive the encrypted information package and store the encrypted information package on at least one information recipient storage for future use.

In an embodiment of the present invention, there is provided a system for secure financial processing, comprising: at least one bank processor implementing at least one hardware security module; at least one merchant marketplace processor communicatively coupled to the at least one bank processor; and at least one client processor communicatively couple to the at least one merchant marketplace processor, the at least one bank processor configured to receive a set of confidential information, the at least one bank processor configured to provide the set of confidential information to the at least one hardware security module, the at least one hardware security module configured to generate a public key and a corresponding private key, the security module configured to homomorphically encrypt the set of confidential information into an encrypted information package, the at least one hardware security module configured to make the encrypted information package available to be communicated to the at least one merchant marketplace processor, the at least one merchant marketplace processor configured to request the encrypted information package and receive the encrypted information package and store the encrypted information package on at least one merchant marketplace storage for future use, and the at least one merchant marketplace processor configured to receive a transaction request from the at least one client processor, the at least one merchant marketplace processor configured to send the encrypted information package to the at least one bank processor to be verified, the at least one bank processor configured to verify the encrypted information package by comparing the encrypted information package to a database, the at least one bank processor configured to provide the comparison result to the at least one hardware security module to verify approval of the transaction and to send the at least one merchant marketplace processor an encrypted verification result to decrypt using the merchant secret key and complete the transaction if the transaction was approved.

### BRIEF DESCRIPTION OF THE DRAWINGS

The principles of the invention may better be understood with reference to the accompanying figures provided by way of illustration of an exemplary embodiment, or embodiments, incorporating principles and aspects of the present invention, and in which:

FIG. 1 is a schematic diagram of an information transfer system, according to an embodiment;

FIG. 2 is a schematic diagram of the information transfer system of FIG. 1, showing further components;

FIG. 3 is a schematic diagram of an information transfer system using a secure API, according to an embodiment; and

FIG. 4 is a flowchart of an example process using the information transfer system of FIG. 3.

### DETAILED DESCRIPTION OF THE EMBODIMENTS

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and in some instances, proportions may have been exaggerated in order more clearly to depict certain features of the invention.

An aspect of this description relates to a system for secure use of confidential information. Confidential information may include financial information, such as a bank card number, a personal identification number (“PIN”), a credit card number, a bank account number and/or type (e.g., savings account, chequing account) or related banking or credit information. Confidential information may also include personal information, such a social insurance number, an address, a phone number, one or more personal preference settings, or other personal information, but is not limited to numerical data (e.g., alphanumeric characters). Different types of confidential information may be combined into a single package for encryption, decryption, and transfer, as required and desired.

An aspect of this description relates to secure computation performed on encrypted data without the decryption of the data. An aspect of this description relates to homomorphic encryption. For example, a hardware security module may be employed to generate a secret key and a public key associated with a homomorphic encryption. In some embodiments a hardware security module retains the secret key or both the secret key and the public key, and only provides encrypted information. In some embodiments, only the hardware security module ever accesses unencrypted information. In some embodiments, a hardware security module is a secure zone of trust within a system.

Homomorphic encryption is an encryption scheme that enables arbitrary computation on ciphertexts without the need to decrypt the ciphertext. Homomorphic encryption may include Fully Homomorphic Encryption (FHE), somewhat homomorphic encryption, partially homomorphic encryption as well as other types of homomorphic encryption. RLWE-based (Ring Learning With Errors) and NTRU-based FHE schemes are two examples, made without limitation, of FHE encryption schemes that may be used.

An aspect of this invention relates to a system which secures client information while the information is being transferred, stored, or processed. An aspect of this invention relates to a system which will allow bank clients to store their bank information on a merchant's website in an encrypted format, yet still allows merchants to perform secure transactions using the encrypted bank information. An aspect of this description relates to a system which leaves a merchant with only encrypted data so that even in the event of a data breach the information cannot be used.

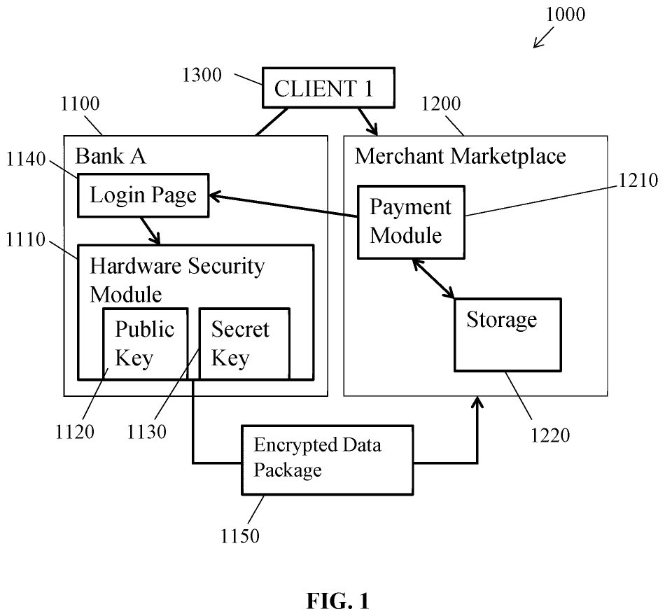

A schematic diagram of an example system is depicted in FIG. 1. System 1000 involves a bank 1100, a merchant marketplace 1200 and a client 1300.

A hardware security module such as Hardware Security Module (“HSM”) 1110 at bank 1100 generates a public key 1120 and a secret key 1130. The HSM 1110 is a physical computing device that manages and safeguards digital keys used in strong authentication as well as providing cryptoprocessing. It can perform encryption and decryption in addition to key generation. The HSM 1110 may further include features to produce evidence of tampering when such is attempted or occurs (e.g., physical indicators, tamper-proof casing, alarms). There may also be internal safeguards, such as secure cryptoprocessing chips to prevent tampering or bus probing, or tamper detection code which deletes keys upon tamper detection and may additionally trigger alerts. The HSM 1110 may also include a backup format to securely back up the keys which are stored on the HSM 1110. The backup format may be computer media (discs) or a secure portable device, such as a smartcard or other security token. The hardware security module as defined herein and shown by way of example as HSM 1110 may alternatively be implemented as a software-based virtual hardware security module, such as on a network-connected desktop or laptop computer or other workstation or a mobile phone or other portable network-connected computing device, and according to embodiments may be cloud-based or may comprise more than one hardware security module or both, all within the meaning of hardware security module as used in this specification. At this time, hardware-based HSMs are more secure than software-based virtual HSMs.

The public key 1120 may be used to encrypt information using an associated fully homomorphic encryption scheme (“FHE”) (or other homomorphic encryption schemes), and the secret key 1130 may be used to decrypt information encrypted using the public key 1120. The public key 1120 and the secret key 1130 are stored at the HSM 1110 for the bank 1100, although the public key 1120 may be transported or provided to other parties.

A client 1300 is able to access a merchant marketplace 1200 and direct the creation of a new payment method using a payment module 1210. This module 1210 incorporates an appropriate software development kit (“SDK”) and gives client 1300 the option of storing the client's information in a homomorphically encrypted format. If the user 1300 accepts, the module 1210 will provide the user 1300 with information regarding the banks that support this capability.

The client 1300 is able to choose bank 1100 from the options provided (e.g., icon, drop-down menu, etc.). The client 1300 is redirected to the bank 1100 log-in page 1140 and required to log in using existing bank credentials. Once the client 1300 is signed in, the client is able to choose an account that is operatively coupled to the HSM 1110, the HSM 1110 encrypts the information that the payment module 1210 requires using the public key 1120 and then sends the encrypted data package 1150 back to the payment module 1210.

Payment module 1210 may store encrypted data package 1150 on a private or public cloud, such as device 1220, since no associated merchant or other actor will be able to decrypt the encrypted data package because the secret key 1130 is held by HSM 1110. To inhibit interception of encrypted data package 1150, bank 1100 may maintain a list of trusted merchant or certified parties to reject packages which are received from unknown or untrusted parties. This process may include a key exchange whereby the bank 1100 is provided with the public key for the merchant marketplace 1200 or using certificates generated from a certificate authority.

The merchant marketplace 1200 may use stored encrypted data package 1150 to complete payment processes anytime the client 1300 makes a purchase. For example, the merchant marketplace 1200 may sell and ship goods or services directly or may sell the goods or services through a companion company but fulfill the order through the merchant marketplace 1200.

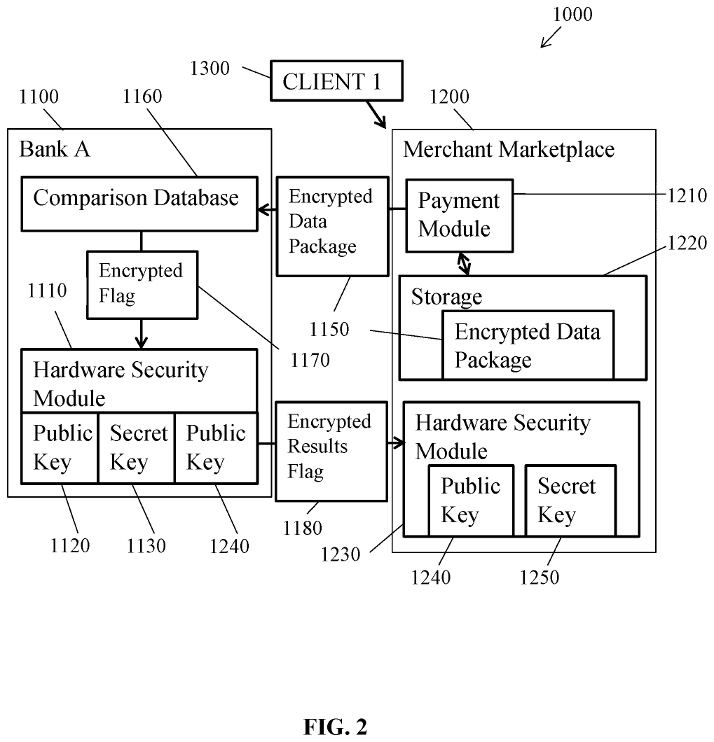

Payment processing is now described with reference to FIG. 2. Using system 1000, client 1300 initiates a transaction by going to a merchant marketplace 1200. Merchant marketplace 1200 may be a merchant website or a software application installed on a device such as an automobile or tablet interface through which a merchant offers a marketplace. The merchant marketplace 1200 also has an HSM 1230. The various entities communicate over one or more computer networks, typically through the Internet, via wired, wireless, optical or other suitable communications mechanism for communicating across computer networks.

Client 1300 then selects a product or service they wish to purchase and initiates the transaction process. Merchant marketplace 1200 accesses an encrypted data package 1150 that it has received from bank 1100, and merchant marketplace 1200 sends the encrypted data package 1150 to bank 1100 for verification. The merchant marketplace 1200 may send additional encrypted or unencrypted data alongside encrypted data package 1150.

Bank 1100 compares encrypted data package 1150 to its own database 1160 of financial information. The database 1160 of bank 1100 may also be encrypted or may include plaintext data. The bank 1100 will use a homomorphic search algorithm to generate an encrypted flag 1170 indicating either a match or a no-match. The encrypted flag 1170 will be sent to HSM 1110. The HSM 1110 contains the secret key 1130 for decryption of the encrypted flag.

The plaintext result of decrypting the encrypted flag 1170 provides a verification of the client bank information as provided, including client name and account balance verification, as encrypted by bank 1100. If sufficient funds and any other conditions necessary for approval of the transaction, such as the account being active or the transaction being within any applicable daily or other transaction limits, are verified, then a verification result will be encrypted as an encrypted results flag 1180 using the merchant marketplace 1200 public key 1240 and sent back to the merchant marketplace 1200 to decrypt using the merchant secret key 1250 and complete the verification process. Merchant marketplace 1200 then uses encrypted results flag 1180 to complete the process, and funds are transferred from an account of the client 1300 to an account of the merchant marketplace 1200. The transaction is thereby completed with decrypting any confidential data and exposing it to attack.

If on the other hand sufficient funds or any other condition necessary for approval of the transaction is not verified, then the verification result will be similarly encrypted as an encrypted results flag 1180 using the merchant marketplace 1200 public key 1240 and sent back to the merchant marketplace 1200 to decrypt using the merchant secret key 1250 and complete the verification process. Merchant marketplace 1200 then uses encrypted results flag 1180 to discover that sufficient funds or some other condition necessary for approval of the transaction could not be verified, and this information may then be communicated to the client who may opt for a different means of payment.

Notably, the above process is transparent to the user, who is able to execute a transaction using their encrypted confidential information without the need to create or remember any additional credentials, as their existing bank credentials (or other secure login) may be used.

If a companion company is involved in the transaction a running total of transaction values for each companion company is stored in storage 1220. Appropriate transaction totals are periodically transferred to each of the companion company accounts registered with the merchant marketplace 1200. A companion company is a third party company which offers products and services through the merchant marketplace provider. Thus, the third party company may offer goods and services securely while relying upon the merchant to provide transaction security through the system, as well as to hold and process funds on their behalf.

Bank 1100 will need to implement platforms to homomorphic encryption key generation, key storage, encryption, decryption, and homomorphic searching. The merchant marketplace 1200 will need to implement a link to redirect to the bank login page 1140, and the merchant marketplace 1200 must have enough space to store the encrypted bank account information coming from bank 1100.

In other embodiments, other types of information may be transferred, processed, verified, and used in a similar manner. For example, instead of bank account information, the subject of the system may be personal identifying information.

While the above example system implements a debit-type transaction directly with a bank, a similar system could be implemented with a credit agency instead of the bank.

As a further example, the information being used may be other confidential information, such as driving history and location information collected by insurance agencies to allow the insurance agencies to evaluate driving history without directly accessing the underlying information or metadata.

Any confidential information can be encrypted, with the secret key kept by a trusted service provider to allow the information to be accessed if needed, while providing the public key to users to employ in processing the information in everyday transactions, if necessary.

As described above, the merchant marketplace 1200 may be a consumer marketplace where a consumer directly purchases goods through the marketplace, either in an open marketplace (e.g., Amazon, Walmart, etc.) or a closed marketplace from a specific provider (e.g., Apple Store, Google Store). Alternatively, the merchant marketplace 1200 may be agency or organization (e.g., a tax authority such as the Canada Revenue Agency (CRA) or the Internal Revenue Service (IRS), a public or private utility, etc.) to which the consumer is authorizing a secure transaction of funds or information or both. In yet another alternative, the merchant marketplace 1200 may be a financial services organization (e.g., a bank, credit union, insurance provider, etc.) which again requires the user to authorize a transfer of funds or information or both. Other forms of financial transactions (e.g., Society for Worldwide Interbank Financial Telecommunication (SWIFT) money transfers, cryptocurrencies) may also be included.

In some embodiments, part of an encrypted package may be kept unencrypted to allow users to verify that they are using the correct package. For example, the last few digits of a credit card number, bank account number, or metadata may be provided, or a label may be applied to the package to allow a user to verify that the correct package is being used.

An aspect of this invention relates to the use of personal information held by a vehicle system such as preference details and payment details. An embodiment of the present system and method is a secure in-vehicle payment system using an on-board hardware security module such as a Hardware Trust Anchor (HTA) (a term used in the automotive industry in reference to a hardware security module) using homomorphic encryption or a secure connection to a merchant marketplace as described above. For example, an on-board hardware security module may be incorporated into a digital marketplace infrastructure of an automotive manufacturer, such as General Motors™ Marketplace connected automobile infrastructure, to allow users to securely purchase goods from their vehicle. Example of transactions include financial transactions at gas pumps, charging stations, parking lots, toll booths, and goods or services purchased via a drive-through delivery system. The hardware security module may also be used to access Internet data, to pay congestion charges, to purchase after-market features, and to enable discounts on vehicle services and accessories. A system can be used in vehicle to vehicle and in vehicle to infrastructure transactions. For example, homomorphic encryption may allow secure transport of infotainment and digital rights management (“DRM”) parameters. In some embodiments, data is only pushed or pulled when the vehicle is parked. Many types of data to be moved are latency insensitive but of high value and potentially large, such as firmware over the air updates, video and music, maintenance, diagnostics, and georoute data.

As discussed above, an embodiment of the present system may be used in government services or other public or private services. For example, the IRS may store confidential information about taxpayers while only providing homomorphically encrypted packages to employees or contractors or outside parties to process in verifying information as needed. A similar storage system may be used by a private or public utility provider (e.g., power, water, Internet) to store confidential customer information which may be shared to employees or outside contractors as needed using homomorphically encrypted packages.

As also discussed above, an embodiment of the present system may be used in money transfer services or other financial transactions. For example, SWIFT or the Large Value System within the Payments Canada Retail ecosystem may use the system to verify information for money transfers. These entities may verify information for the participating financial institutions, as well as the financial institutions themselves.

An embodiment of the present system may also be used in secure contracts within blockchains. For example, a cryptocurrency such as Ethereum™ may employ the system in verifying transferred information.

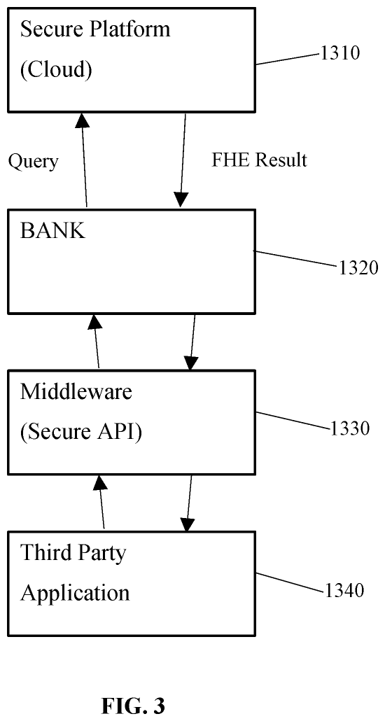

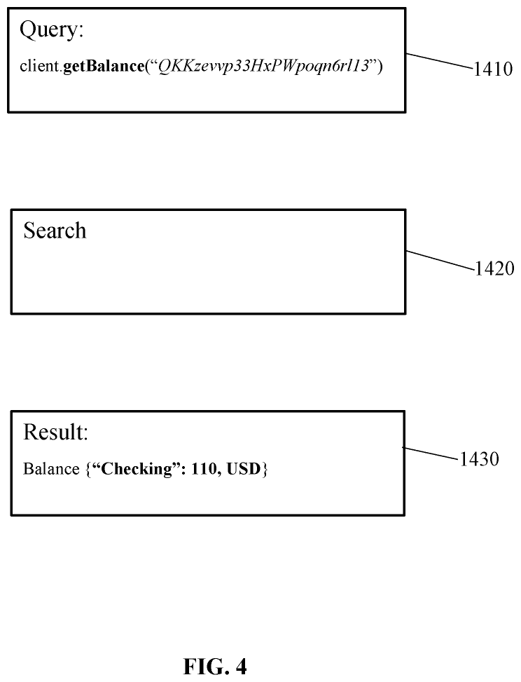

Another embodiment of the present system may be provided as a secure API for a system such as open banking. The secure API enables a method for third party applications to use only encrypted information to operate while providing security and privacy to the client, as shown in the example for a banking application in FIGS. 3 and 4.

Another embodiment of the present system may be provided in the context of use with an authentication/access delegation protocol such as OAuth to grant access to the client account and where applications are then built using a collection of secure APIs that make use of FHE technology for secure search and arithmetic operations such as needed in open banking. In some embodiments, the secure API enables a method for third party applications to use only encrypted information to operate (e.g., encrypted account number, account balance, deposit or withdrawal amount, etc.) while providing security and privacy to the client, as shown in the example for a banking application in FIGS. 3 and 4. In some embodiments, FHE technology is used by or implemented at one or more databases of a bank to ensure privacy and security of the data stored in the database(s) and third party applications can use a standard or plaintext API interface to access data generated by the bank. For example, a client may make a request for data from the bank through a third party application. If a request for data is made to a database, for example, by a component of the bank system, the FHE technology can be used to generate encrypted data and provide same to that component, which can use that encrypted data to generate additional data, such as a verification flag, to be provided to the third party application. For example, the bank component can send a request to the database for a search that involves string matching the encrypted data and, if a match is found, the result can be sent to the bank component which can then decrypt the data received to produce other data that can be used to respond to a third party application request. Third party applications can then use a standard or plaintext API interface to access data (e.g., a verification flag).

The secure API incorporates a secure platform 1310 (e.g., a cloud platform) containing the encrypted confidential information for a bank 1320 as described above. A third party application 1340 that wishes to access banking functions may then access the bank via a middleware application 1330 which provides a secure API for information transfer. Third party application 1340 is a client-facing application that provides, in the present example, different banking-related services to the client. Middleware applications 1330 are applications that provide an interface (e.g., a secure API) that enable the third party application 1340 to connect to the bank 1320 and the bank's software systems to enable the transfer of confidential information. Middleware applications may be created and provided by the bank, or by another party (e.g., Plaid™ or Flinks™ in the banking environment). If desired, a Certificate Authority may be used to establish the identity of transmitting entities in this process.

Two sets of keys are required to execute a transfer. The first set of public/private keys (PK1, SK1) are generated at the bank, with PK1 used to encrypt the confidential information in secure platform 1310, and SK1 used to decrypt the results. The second set (PK2, SK2) are generated at the third party application 1340, with PK2 sent to the bank 1320 to encrypt (i.e., re-encrypt) the final results sent back to the third party application 1340. All keys should be generated via a hardware security module and all operations requiring keys should take place within the hardware security module or HSM zone of trust.

As shown in FIGS. 3 and 4, using the example of a balance check request, to set up a secure transfer through the secure API, the process proceeds in two phases. In the first phase, through the third party application 1340, the client selects their bank 1320, which activates the login credentials request for that bank. The client then submits their credentials, and the bank 1320 generates the FHE encrypted account information and sends it through the secure API 1330 to the third party application 1340. The encrypted account information may include one or more bank accounts or other financial products held by the client, or a unique identifier to represent that specific client to the bank, or any other confidential information held and able to be transferred by the bank, including combinations of information.

With the registration phase completed, the client may then execute requests through the third party application 1340 and the third party application 1340 may use the FHE encrypted information as provided by the bank 1320 through the secure API 1330 to perform these requests. As shown in FIG. 4, a balance request 1410 is made using the encrypted string “QKKzevvp33HxPWpoqn6rl13” (n.b., this encrypted string is greatly simplified and shortened for the purpose of representation in this specification as an actual ciphertext is significantly larger in length), which is the subjected to a search 1420 of the encrypted information for a matching string and, once found, the result is sent out and, once decrypted, produces the account type and balance (U.S. Dollar Checking account, $110).

As discussed above, other entities may be used in place of bank 1320 in the above transaction. For example, other types of financial service providers, or public or private agencies, may participate using the secure API system. Further, requests, such as a change of address, may be performed on other types of confidential information, such as personal identity information, according to the needs of the client and the provider of the third party application 1340.

In some embodiments, full hardware security modules become default hardware trust anchors (“HTAs”). In some embodiments, HTAs protect sensitive data in ways that software cannot manipulate and provide cryptography functions, such as elliptic curve digital signature algorithm (“ECDSA”) signature generation, to unburden the host controller.

In some embodiments, different standardised features sets are used for HTAs, either secure hardware extensions (“SHEs”) or hardware security modules (“HSMs”) with programmable cryptography space. For example, brands for HTAs by different suppliers include Infineon™ Aurix HSM and SHE+ driver, Renesas™ Intelligent Cryptographic Unit (“ICU”), Freescale™ or NXP™ Crypto Service Engine (“CSE”), ST Micro™ Crypto Service Engine (“CSE”), ARM™ Trust Zone, and established HSM players Utimaco™ and THALES™.

In some embodiments, an HSM is able to generate public and secret keys, homomorphically encrypt plaintext using a public key, and decrypt a ciphertext using a secret key.

Various embodiments of the invention have been described in detail. Since changes in and or additions to the above-described best mode may be made without departing from the nature, spirit or scope of the invention, the invention is not to be limited to those details but only by the appended claims.

What is claimed is:

1. A system for governing information transfers, comprising:
at least one information provider processor implementing at least one hardware security module; and
at least one information recipient processor communicatively coupled to the at least one information provider processor,
the at least one information provider processor configured to receive a set of confidential information, the at least one information provider processor configured to provide the set of confidential information to the at least one hardware security module,
the at least one hardware security module configured to generate a public key and a corresponding private key, the at least one hardware security module configured to homomorphically re-encrypt the set of confidential information into an encrypted information package, the at least one hardware security module configured to make the encrypted information package available to be communicated to the at least one information recipient processor, and
the at least one information recipient processor configured to request the encrypted information package and receive the encrypted information package and store the encrypted information package on at least one information recipient storage for future use.

2. The system of claim 1, wherein the at least one information recipient processor is further configured to receive an action request from at least one client processor, the action request directing the at least one information recipient processor to send the encrypted information package to at least one target processor, the at least one target processor communicatively coupled to the at least one information recipient processor, the at least one information recipient processor further configured to send the encrypted information package to the at least one target processor.

3. The system of claim 1, wherein the at least one hardware security module is configured to implement homomorphic encryption, and the encrypted information package is a homomorphically encrypted package.

4. The system of claim 3, wherein the homomorphic encryption is a fully homomorphic encryption scheme.

5. The system of claim 3, wherein the homomorphic encryption is a somewhat homomorphic encryption scheme.

6. The system of claim 3, wherein the homomorphic encryption is a partially homomorphic encryption scheme.

7. The system of claim 1, wherein the at least one information provider processor is associated with one of a financial institution and a marketplace provider.

8. The system of claim 1, wherein the set of confidential information includes one or more of: a set of financial information and a set of personal identifying information.

9. The system of claim 1, wherein the at least one hardware security module is an isolated module shielded from other modules implemented by the at least one information provider processor.

10. The system of claim 1, further comprising at least one companion processor communicatively coupled to the at least one information recipient processor to receive information from the at least one recipient processor.

11. The system of claim 1, wherein the at least one information recipient storage is a cloud storage.

12. The system of claim 1, wherein the encrypted information package includes an unencrypted identifying set of information.

13. The system of claim 1, wherein the encrypted information package is associated with a label.

14. The system of claim 1, wherein the one information recipient processor is communicatively coupled to the at least one information provider processor through a secure middleware application.

15. A system for secure financial processing, comprising:
at least one bank processor implementing at least one hardware security module;
at least one merchant marketplace processor communicatively coupled to the at least one bank processor; and
at least one client processor communicatively coupled to the at least one merchant marketplace processor,
the at least one bank processor configured to receive a set of confidential information, the at least one bank processor configured to provide the set of confidential information to the at least one hardware security module,
the at least one hardware security module configured to generate a public key and a corresponding private key, the at least one hardware security module configured to homomorphically encrypt the set of confidential information into an encrypted information package, the at least one hardware security module configured to make the encrypted information package available to be communicated to the at least one merchant marketplace processor,
the at least one merchant marketplace processor configured to request the encrypted information package and receive the encrypted information package and store the encrypted information package on at least one merchant marketplace storage for future use, and
the at least one merchant marketplace processor configured to receive a transaction request from the at least one client processor, the at least one merchant marketplace processor configured to send the encrypted information package to the at least one bank processor to be verified,
the at least one bank processor configured to verify the encrypted information package by comparing the encrypted information package to a database, the at least one bank processor configured to provide the comparison result to the at least one hardware security module to verify approval of the transaction and to send the at least one merchant marketplace processor an encrypted verification result to decrypt using the merchant secret key and complete the transaction if the transaction was approved.

16. The system of claim 15, wherein the at least one hardware security module is configured to implement homomorphic encryption, and the encrypted information package is a homomorphically encrypted package.

17. The system of claim 16, wherein the homomorphic encryption is a fully homomorphic encryption scheme.

18. The system of claim 16, wherein the homomorphic encryption is a somewhat homomorphic encryption scheme.

19. The system of claim 16, wherein the homomorphic encryption is a partially homomorphic encryption scheme.

20. The system of claim 15, wherein the set of confidential information includes one or more of: a set of financial information and a set of personal identifying information.

21. The system of claim 15, wherein the at least one merchant marketplace storage is a distributed storage.

22. The system of claim 15, wherein the at least one merchant marketplace storage is a cloud storage.

23. The system of claim 15, wherein the encrypted information package includes an unencrypted set of identifying information.

24. The system of claim 15, wherein the encrypted information package is associated with a label.

25. The system of claim 15, wherein the at least one merchant marketplace processor communicatively coupled to the at least one bank processor through a secure middleware application.
